(19) United States
(12) Patent Application Publication
(10) Pub. No.: US 2003/0047818 A1
(43) Pub. Date: Mar. 13, 2003

(54) Fuel metering assembly for a diaphragm-type carburetor

(75) Inventor: Noriyu Nagata, Miyagi-ken (JP)

Correspondence Address: REISING ETHINGTON BARNES KISSELLE, LEARMAN AND MCCULLOCH PC, P O BOX 4390, TROY, MI, 48099-4390, US

(73) Assignee: Walbro Japan, Inc., Noriyu Nagata (JP)

(21) Appl. No.: 10/218,737

(22) Filed: Aug. 14, 2002

(30) Foreign Application Priority Data
Aug. 23, 2001 (JP) 2001-253551

(51) Int. Cl. F02M 17/04

(52) U.S. Cl. 261/35; 261/69.1; 261/DIG. 68

(57) ABSTRACT

A fuel metering assembly for a diaphragm type carburetor has a fuel metering diaphragm with at least two convolutions or annular projections providing greater travel of the diaphragm and more consistent movement of the diaphragm throughout its stroke or travel. In one embodiment, the diaphragm has at least one annular projection generally U-shaped in section projecting toward a fuel metering chamber defined on one side of the diaphragm, and at least one annular projection having a generally inverted U-shape in section projecting toward an atmospheric chamber defined on the other side of the diaphragm. Preferably, the annular projections are continuously provided between the peripheral edge of the diaphragm and a central portion of the diaphragm.

### REFERENCE TO RELATED APPLICATION

Applicant claims priority of Japanese Application, Serial No. 2001253,551, filed Aug. 23, 2001.

### FIELD OF THE INVENTION

The present invention relates to a diaphragm type carburetor, and more particularly to a diaphragm type carburetor for an internal combustion engine.

### BACKGROUND OF THE INVENTION

In diaphragm type carburetors for small internal combustion engines, the carburetor body is small relatively, and the radius of curvature of an annular projection 63A of a diaphragm 61 of a fuel metering assembly is set to be large, as shown in FIG. 4, in order to obtain a desired stroke of the diaphragm. However, when the radius of curvature of the annular projection 63A is large, there is a difference in diameter caused by the thickness of the annular projection 63A between one surface and the other surface of the diaphragm 61. The difference in diameter leads to distorted or non-uniform movement of the diaphragm 62, and also adversely affects the actuating characteristics of the diaphragm 61. When a reduced pressure, or vacuum, exists in the fuel metering chamber 18, the diaphragm 61 begins to move to actuate the fuel metering lever, but the irregular operation of the diaphragm causes irregular actuation of the metering lever leading to relatively inconsistent fuel metering for the carburetor. If the radius of curvature of the annular projection 63A of the diaphragm 61 is made small, the stroke or amount of movement of the diaphragm 61 is small, resulting in trouble opening and closing the fuel metering valve.

### SUMMARY OF THE INVENTION

A fuel metering assembly for a diaphragm type carburetor has a fuel metering diaphragm with at least two convolutions or annular projections providing greater travel of the diaphragm and more consistent movement of the diaphragm throughout its stroke or travel. In one embodiment, the diaphragm has at least one annular projection generally U-shaped in section facing toward a fuel metering chamber defined on one side of the diaphragm, and at least one annular projection having a generally inverted U-shape in section facing toward an atmospheric chamber defined on the other side of the diaphragm. Preferably, the annular projections are continuously provided between the peripheral edge of the diaphragm and a central portion of the diaphragm.

This embodiment of diaphragm has smoother, more consistent actuation and movement and a relatively long stroke to facilitate actuating a valve that controls fuel flow into the fuel metering chamber. It is noted that the annular projection is not limited to one, but a plurality of annular projections may be formed continuously in the form of a wave or waves in section.

### BRIEF DESCRIPTION OF THE DRAWINGS

These and other objects, features and advantages of the invention will be apparent from the following detailed description of the preferred embodiment, appended claims and accompanying drawings, in which:

FIG. 1 is a front sectional view of a diaphragm type carburetor provided with a fuel metering assembly according to the present invention;

FIG. 2 is a front sectional view of a diaphragm of the fuel metering assembly;

FIG. 3 is a diagram representative of the actuating characteristics of the diaphragm in the fuel metering assembly; and

FIG. 4 is a front sectional view of a diaphragm of a prior art fuel metering supply mechanism.

### DETAILED DESCRIPTION OF THE PREFERRED EMBODIMENTS

As shown in FIG. 1, in one embodiment of the invention, a diaphragm type carburetor has a carburetor body 31 with a fuel pump A therein, an air intake passage 32 which extends through the carburetor body 31, and a fuel metering assembly B. The fuel pump A has a diaphragm 9, a gasket 8 and a cover plate 2 carried by the body 31 and preferably fastened by a bolt 3. A crankcase pressure chamber 7 for receiving pressure pulses in a crankcase chamber of a 2-stroke engine and applying them to the diaphragm 9 is defined on one side of the fuel pump diaphragm 9 and a pump chamber 10 is defined on the other side of the diaphragm 9. The fuel metering assembly B has a gasket 20, a diaphragm 61 and a cover plate 23 are carried by the body 31 and preferably fastened by means of bolts. A fuel metering chamber 18 is defined on one side of the diaphragm 61 and an atmospheric chamber 22 is defined on the other side of the diaphragm 61.

The fuel metering assembly also has a vertically extending passage 14 provided in the body 31, a filter 12 disposed in the upper end of the passage 14, a valve seat 13 provided in an intermediate portion of the passage 14 and a poppet type inlet valve 15 slidably received in a lower end of the passage 14. The inlet valve 15 is yieldably biased into engagement with the valve seat 13 by the force of a spring 17. The lower end of the inlet valve 15 is connected to one end of a lever 19. The lever 19 has an intermediate portion rotatably supported on the wall of the body 31 by a support shaft 16. The other end of the lever 19 (opposite the inlet valve 15) is placed in contact with a projection 21 a on the diaphragm 61 by the force of the spring 17 which is interposed between the lever 19 and the lower surface of the body 31.

When the diaphragm 9 is actuated up and down by pressure pulses from the crankcase chamber of the engine, fuel in a fuel tank (not shown) is drawn into the pump chamber 10 via an inlet valve of the fuel pump, and supplied to the passage in the cover plate 2 via a discharge valve, and to the fuel metering chamber 18 via the inlet valve 15 from the pump chamber 10. When the fuel metering chamber 18 is filled with fuel, the diaphragm 61 moves down (as viewed in FIG. 1) toward the atmospheric chamber 22, the inlet valve 15 is placed in contact with the valve seat 13 by the lever 19 receiving the force of the spring 17 to discontinue fuel supply from the fuel pump A to the fuel metering chamber 18.

Fuel in the fuel metering chamber 18 is taken into the air intake passage 32 via a passage 27, a valve chamber 36 and a fuel passage 30 The valve chamber 36 has a threaded hole 44 and an end of the valve chamber 36 is narrow to receive a tapered needle 37a of a fuel adjusting needle valve 37. The needle valve 37 is integrally provided with a head portion 37c, a threaded portion 37b threaded in the threaded hole 44 and the tapered needle 37a. A spring 33 wound about the threaded portion 37b is accommodated in a counterbore 25 of the valve chamber 36 that has a larger diameter than the threaded hole 44. The spring 33 is interposed between an end wall of the counterbore 25 and the head portion 37c of the fuel adjusting needle valve 37 to prevent unintended rotation of the needle valve 37.

The cover plate 2 preferably has an L-shaped arm 4 projecting outwardly from the cover plate. The arm 4 receives a bolt 6 having a tapered end and a spring 5 is interposed between the arm 4 and the head portion of the bolt 6. The tapered end of the bolt 6 comes in contact with a throttle valve lever, not shown, to permit adjustment and control of an idling position of the throttle valve rotatably supported in the air intake passage 32.

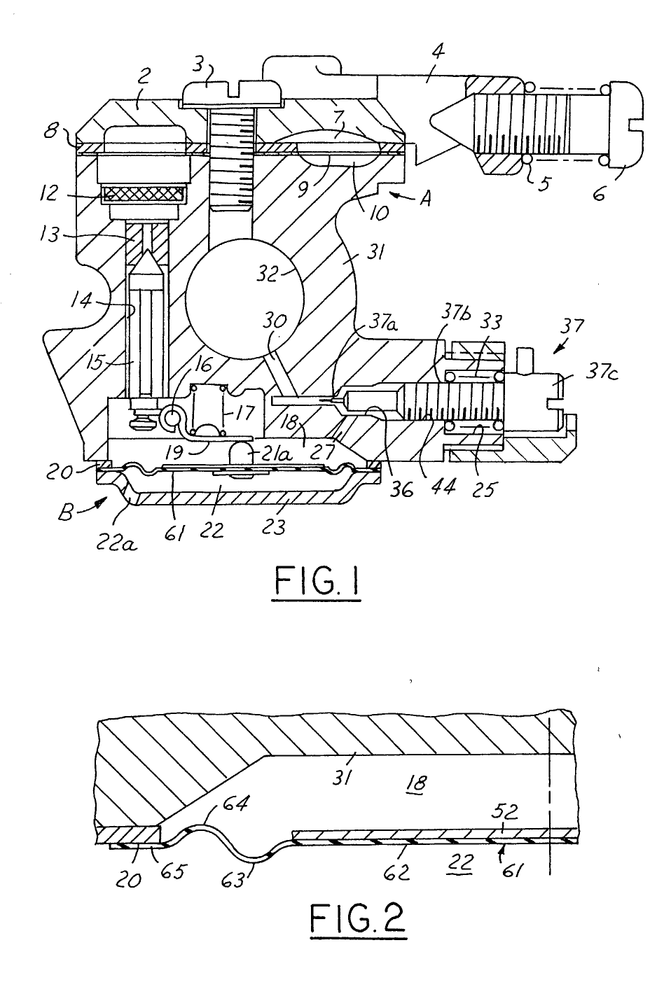

As shown in FIG. 2, according to one embodiment of the present invention, the diaphragm 61 that defines the fuel metering chamber 18 and the atmospheric chamber 22 is held about its outer peripheral edge 65, together with a gasket 20, between the body 31 and the cover plate 23. A stiffening plate 52 is put on and connected to the surface of a central portion 62 of the diaphragm 61 by an adhesive or the like, and a projection 21a, shown in FIG. 1, is connected thereto. An annular projection 63 having a U-shape in section facing toward the fuel metering chamber 18 and an annular projection 64 having an inverted U-shape in section facing toward the atmospheric chamber 22 are integrally formed radially between the peripheral edge 65 and the central portion 62 of the diaphragm 61. Each of the annular projections 64 and 63 is not limited to one, but a plurality of annular projections may be formed continuously in the form of a wave in section.

During operation of the engine, the intake vacuum pressure in the air intake passage 32 and the force of the spring 17 are provided in the fuel metering chamber 18 and act on the diaphragm 61. Further, atmospheric pressure acts on the lower surface of the diaphragm 61 (surface in contact with the atmospheric chamber 22) through a vent 22a. When the amount of fuel in the fuel metering chamber 18 decreases, the diaphragm 61 is displaced against the force of the spring 17, causing the lever 19 to rotate counterclockwise (as viewed in FIG. 1) about the shaft 16 so that the inlet valve 15 is opened, and fuel from the fuel pump A is supplied to the fuel metering chamber 18. When the fuel metering chamber 18 is filled with fuel, the diaphragm is displaced toward the atmospheric chamber 22. The lever 19 is rotated clockwise (as viewed in FIG. 1) by the force of the spring 17, and the inlet valve 15 closes.

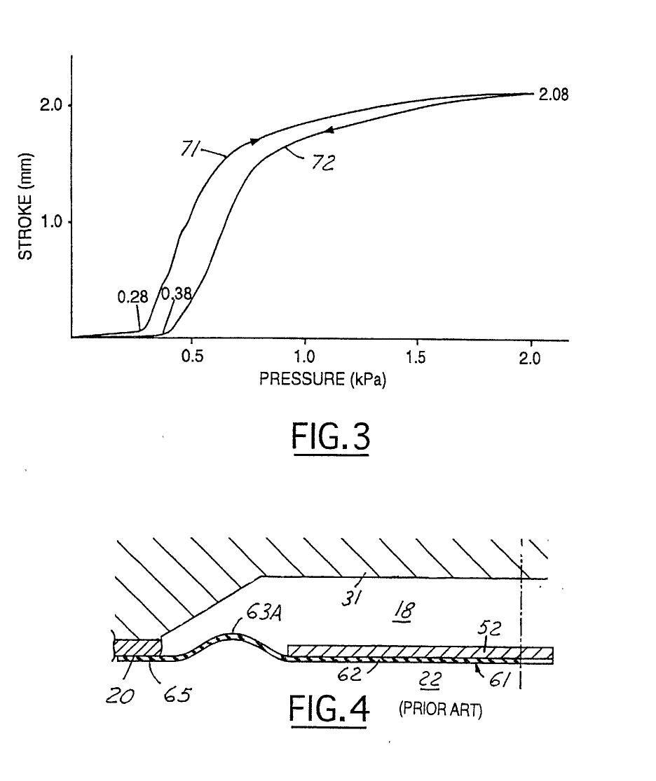

When the volume of the fuel metering chamber 18 is reduced by movement of the diaphragm 61, the amount of movement from the neutral position of the diaphragm 61 increases, as shown by line 71 in FIG. 3. When the volume of the fuel metering chamber 18 is increased by movement of the diaphragm 61, the amount of movement of the diaphragm 61 increases, as shown by line 72 in FIG. 3. Thus, as shown in FIG>3, the diaphragm 61 operates more consistently (with less variation) between its upward and downward strokes (as viewed in FIG. 1). In the conventional shape of diaphragm, shown in FIG. 4, a stroke difference at pressure from about 0.5 to about 0.9 kPa exerted on the diaphragm was only 0.8 mm, whereas in the diaphragm 61 according to the present invention, a stroke difference at pressure from about 0.5 to about 0.9 kPa exerting on the diaphragm was about 1.8 mm.

The diaphragm 61 according to one embodiment of the present invention is provided with the annular projections 64 and 63 having an inverted U-shape and a U-shape in section, respectively. Therefore, when the radius of curvature of the projections 64 and 63 deform in a direction increasing the volume of the atmospheric chamber 22, the compressed distortion occurring on the upper surface of the projection 64 is offset by the tensile distortion occurring on the surface of the projection 63, and the compressed distortion occurring on the lower surface of the projection 63 is offset by the tensile distortion occurring on the upper surface of the projection 64 (as viewed in FIG. 1). The difference in drag caused by the diaphragm distortion when the diaphragm 61 moves upward and drag caused by the diaphragm distortion when the diaphragm 61 moves downward, is small. Therefore, the actuation of the diaphragm is smooth, the actuating characteristics are substantially linear and a large amount of diaphragm movement, or stroke, is obtained.

Particularly, a small difference and more consistent operation of the diaphragm (less hysteresis) is obtained between upward movement of the diaphragm when the volume of the fuel metering chamber is decreased and downward movement of the diaphragm when the volume of the fuel metering chamber is increased.

I claim:

1. A fuel metering assembly, comprising:
a body having a cover plate;
a fuel pump carried by the body;
a fuel metering assembly carried by the body and having an inlet valve and a diaphragm carried about its periphery between the body and the cover plate, defining a fuel metering chamber on one side of the diaphragm that is in communication with the fuel pump, and having at least two convolutions spaced radially inwardly from the periphery of the diaphragm to permit the diaphragm to be displaced in directions increasing and decreasing the volume of the fuel metering chamber to control the opening and closing of the inlet valve and the admission of fuel into the fuel metering chamber.

2. The fuel metering assembly of claim 1 wherein said at least two convolutions define an annular projection having a U-shape in section and an annular projection having an inverted U-shape in section.

3. The fuel metering assembly of claim 1 wherein the diaphragm has a generally flat central portion and said convolutions are disposed radially between the periphery of the diaphragm and the central portion.

4. The fuel metering assembly of claim 2 wherein the annular projections are immediately adjacent to each other.

5. The fuel metering assembly of claim 2 wherein the difference in diameters of the projections is small.

6. The fuel metering assembly of claim 1 wherein the diaphragm is made of rubber.

7. The fuel metering assembly of claim 1 wherein the diaphragm is made of an elastomer.

8. The fuel metering assembly of claim 1 wherein the diaphragm is made of a composite material.
